(19) United States
(12) Patent Application Publication
(10) Pub. No.: US 2010/0282933 A1
(43) Pub. Date: Nov. 11, 2010

(54) Universal Unimount

(76) Inventor: Bruce G. Phillips, Gilbert, AZ (US)

Correspondence Address: AVERILL & GREEN, 8244 PAINTER AVE., WHITTIER, CA, 90602, US

(21) Appl. No.: 12/776,108

(22) Filed: May 7, 2010

Related U.S. Application Data
(60) Provisional application No. 61/176,896, filed on May 9, 2009.

(51) Int. Cl. F16M 13/02

(52) U.S. Cl. 248/218.4

(57) ABSTRACT

A junction box mounting bracket attaches to a vertical stud. A box mounting section is sandwiched between a junction box and a plaster ring. A stud attachment section includes screw holes for attaching to the face of the stud and an extending section reaches past the stud to allow attachment of a second junction box mounting bracket on an opposite side of the stud. The extending section further leverages the mounting bracket against a rear drywall surface to eliminate the need for the bracket to wrap around the vertical stud or to brace the junction box against a side surface of the stud. A ganging section reaches past the box mounting section for attachment to the extending section of an adjacent bracket. A narrow brace is attachable above or below the junction box to allow access to knock-outs on the side of the junction box opposite the stud.

The present application claims the priority of U.S. Provisional Patent Application Ser. No. 60/176,896 filed May 9, 2009, which application is incorporated in its entirety herein by reference.

### BACKGROUND OF THE INVENTION

The present invention relates to mounting junction boxes and in particular to a stud mountable bracket for mounting junction boxes.

It is often preferred to connect a junction box to a stud to support the junction box. Various brackets have been devised for this purpose, and often work well. For example, U.S. Pat. No. 4,533,060 for “Mounting Bracket Electrical Outlet Boxes” discloses a bracket with an attachment section which wraps around a vertical stud and is attached to both a face and an opposite side of the stud by screws or the like. The bracket further includes a box mounting section having a central opening for access to a junction box mounted to the back of the bracket. In many simple installations, the bracket of the '060 patent is adequate, but unfortunately, the '060 patent does not always provide adequate support to the side of the junction box opposite to the vertical stud.

U.S. Pat. No. 4,757,908 for “Dual Size Outlet Box Mounting Bracket” discloses a junction box mounting bracket attached to a vertical stud, with a brace on the side of the bracket opposite the stud, the brace reaching to a surface behind the junction box. The brace provides the support missing in the '060 patent. However, the brace of the '908 patent blocks access to some of the knock-outs on the side of the junction box adjacent to the brace while the vertical stud blocks access to knock-outs on the opposite side.

U.S. Pat. No. 5,450,974 for “Mounting Plate and Cover Assembly for an Electrical Outlet Box” discloses a junction box mounting bracket attached to a vertical stud. The bracket positions one side of the box in direct contact with a flat surface of the vertical stud to brace the box. Unfortunately, the brace of the '974 patent does not provide a sturdy mount against an open side of a prefab stud.

### BRIEF SUMMARY OF THE INVENTION

The present invention addresses the above and other needs by providing a junction box mounting bracket which attaches to a vertical stud. A stud attachment section includes screw holes for attaching the bracket to the face of the vertical stud. An extending section reaches past the stud to allow attachment of a second junction box mounting bracket to allow ganging junction boxes on opposite sides of the vertical stud and includes alignment features for aligning the two brackets. The extending section further leverages the mounting bracket against the rear of a drywall surface to eliminate the need for a rear bracket support to rest against an opposing surface of a drywall panel mounted against an opposite face of the stud to support the box/bracket assembly. A ganging section reaches past the box mounting section for attachment to the extending section of an adjacent bracket. A narrow brace is attachable above or below the junction box position as needed to allow access to knock-outs on the side of the junction box opposite to the vertical stud, only covering one knockout on the top or bottom. The narrow brace may be required if a second bracket is “ganged” with a first bracket, both residing on the same side of the vertical stud. The brace is generally not needed when only one mounting bracket is present and is directly mounted to the vertical stud, or when two mounting brackets are ganged across the vertical stud.

In accordance with one aspect of the invention, there is provided the junction box mounting bracket which does not require any back/rear box support. The mounting bracket includes an extending section extending past a vertical stud which the mounting bracket is attached to. The extended length is leveraged against a rear drywall surface to prevent or resist the mounting bracket from pushing back into the wall when force is applied to the face of the mounting bracket or the plaster ring.

In accordance with another aspect of the invention, there is provided an a junction box mounting bracket which allows boxes to be “ganged” together side-by-side, as many boxes as will fit in a stud cavity. Each mounting bracket includes alignment and attachment features on a right edge which cooperates with features on an extending section of a second ganged mounting bracket to allow ganging of the brackets. The stud attachment section spaces adjacent boxes apart to allow access to knock-outs. The alignment and attachment features preferably include two projections and matching receiving holes for exact mounting alignment and two screws for attaching the brackets.

In accordance with yet another aspect of the invention, there is provided a junction box mounting bracket allowing boxes to be ganged together on either the left or the right of a stud, even when one bracket is covering the face of the stud. The mounting bracket includes an extending section extending past the vertical stud which an adjacent mounting bracket may be attached to. The extending section includes alignment and attachment features which cooperate with features on the ganging section of the adjacent ganged mounting bracket to allow mounting junction boxes at the same height on opposite sides of the vertical stud.

In accordance with yet another aspect of the invention, there is provided a rear box support used to support ganged together junction boxes in a wall cavity. A single support is furnished for 2.5″, 3.5″, 5.5″ and 6″ wall depths, including scoring and the like, allowing a portion of the support to be snapped off at appropriate depth requirement. The support can be mounted either above the junction box or below, and does not cover either side of the box, thereby allowing the installer to access side knock-out on at least one side of the box.

In accordance with yet another aspect of the invention, there is provided a junction box mounting bracket allowing any four inch square or 4 11/16 inch square junction box to be used.

In accordance with yet another aspect of the invention, there is provided a junction box mounting bracket allowing commercially available plaster/mud rings to be orientated in any position, i.e. vertical, horizontal, in cooperation with any four inch square or 4 11/16 inch square junction box.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a perspective view of a junction box mounting bracket according to the present invention.

FIG. 2 is a perspective view of three of the junction box mounting brackets according to the present invention ganged and attached to a vertical stud.

FIG. 3 is a front view of the junction box mounting bracket according to the present invention.

FIG. 4 is a vertical cross-sectional view of the junction box mounting bracket according to the present invention taken along line 4-4 of FIG. 3.

FIG. 5 is a horizontal cross-sectional view of the junction box mounting bracket according to the present invention taken along line 5-5 of FIG. 3.

FIG. 6 is a cross-sectional view of detail 6 of FIG. 4.

FIG. 7 is a perspective view of a brace according to the present invention used with the mounting bracket.

FIG. 8A is a side view of the brace.

FIG. 8B is a top view of the brace.

FIG. 8C is an end view of the brace.

FIG. 9A is a side view of the bracket, brace, junction box, and plaster ring before assembling.

FIG. 9B is a side view of the bracket, brace, junction box, and plaster ring after assembling according to the present invention.

FIG. 10 is a side view of detail 10 of FIG. 9B.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

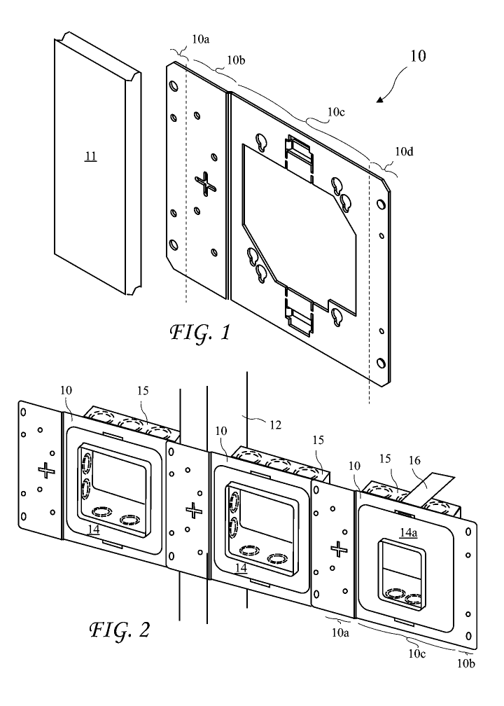

A perspective view of a junction box mounting bracket 10 according to the present invention is shown in FIG. 1, and a perspective view of three of the junction box mounting brackets 10 according to the present invention ganged and attached to a vertical stud 12 is shown in FIG. 2. The mounting bracket 10 is generally sandwiched between a plaster ring 14 and a junction box 15 when installed. The mounting bracket 10 is compatible with both two gang plaster rings 14 and single gang plaster rings 14a, and either four inch or 4 11/16 inch junction boxes 15.

The mounting brackets 10 include an extending section 10a, a stud attachment section 10b, a box mounting section 10c, and a ganging section 10d. The stud attachment section 10b attaches to the stud 12 for mounting the bracket 10 to the stud 12. The extending section 10a reaches past the stud 12 providing both leverage to brace against rear face of drywall 11 to eliminate need to wrap the bracket around stud, and reaching past the stud 12 to allow ganging across the stud. The stud attachment section 10b is forward offset from the box mounting section 10c about the thickness of the plaster ring 14 so that the outward face of the plaster ring (i.e., the face opposite to the mounting bracket) lies in the same plane as the outward face of the stud attachment section 10b (i.e., the face opposite to the stud 12.)

The extending section 10a and stud attachment section 10b lay against a back side of the drywall 11, and contact the drywall 11 to provide resistance to pushing the mounting bracket 10 rearward into the wall, and as a result only two screws, or other fasteners, are required to fix the mounting bracket to the stud 12. As a result, a rear brace and/or wrapping the bracket around the opposite side of the stud 12 and/or bracing a side the junction box 15 against the stud 12, is not required for a single mounting bracket 10, or when one additional bracket 10 is ganged immediately on the opposite side of the stud 12.

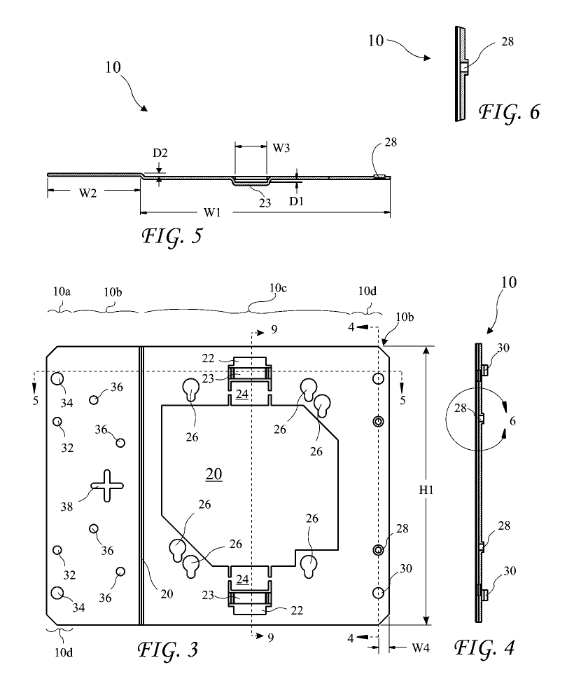

When mounting brackets 10 are ganged, the ganging section 10d overlays the extending section 10a of an adjacent mounting bracket. The adjacent mounting brackets are aligned using alignment features 30 and first cooperating features 34 (see FIGS. 3 and 4) and are attached with fasteners, for example, screws, through second cooperating features 32 into receptacles 28. The overlapped sections of ganged mounting brackets 10 are sufficiently spaced apart from the box mounting section 10c by the stud attachment section 10b, on a side of the vertical stud 12 opposite to the box mounting section 10c, to prevent the overlapping sections from overlapping the vertical stud 12 and causing the drywall to bulge.

A brace 16 is attachable to the mounting bracket either above or below the attached junction box 15. The brace 16 is used when one or more additional mounting brackets 10 are ganged with a bracket 10 attached directly to the vertical stud 12, and at least two of the mounting brackets 10 are on the same side of the stud 12. Known mounting brackets include braces to the side of the junction box 15, and thereby preclude using the knock-outs on the adjacent side of the junction box 15, while the stud 12 precludes using the knock-outs on the opposite side of the junction box 15, thereby preventing use of all of the side knock-outs.

A front view of the junction box mounting bracket 10 according to the present invention is shown in FIG. 3, a vertical cross-sectional view of the junction box mounting bracket 10 taken along line 4-4 of FIG. 3 is shown in FIG. 4, a horizontal cross-sectional view of the junction box mounting bracket 10 taken along line 5-5 of FIG. 3 is shown in FIG. 5, and a cross-sectional view of detail 6 of FIG. 4 is shown in FIG. 6. The mounting bracket 10 is attached to the stud 12 (see FIG. 2) using screws, or the like through holes 36. Four holes 36 are provided for versatility, but only two holes are required to attach the mounting bracket 10 to the stud 12. A cross 38 is vertically centered on the stud attachment section 10b to allow vertical and/or horizontal alignment of the mounting bracket 10 on a pre-marked stud 12. The extending section 10a and the stud attachment section 10b are preferably forward offset from the box mounting section 10c and the ganging section 10d so that the adjacent brackets are ganged, the box mounting sections 10c are aligned.

A mouth 20 is provided in the mounting bracket 10 for access to the interior of the junction box 15. Keyed holes 26 are provided for attachment of the plaster ring 14 and junction box 15. One keyed hole 26 is provided in each of the top left and bottom right and two diagonally offset holes 26 are provided in the top right corner and bottom left corner for mounting the plaster rings 14 and boxes 15. Only two of the holes 26 are generally used for mounting the plaster rings and boxes, and the additional holes are provided for convenience during installation, for example, so the installer is not required to rotate the rings and boxes into different positions to achieve alignment.

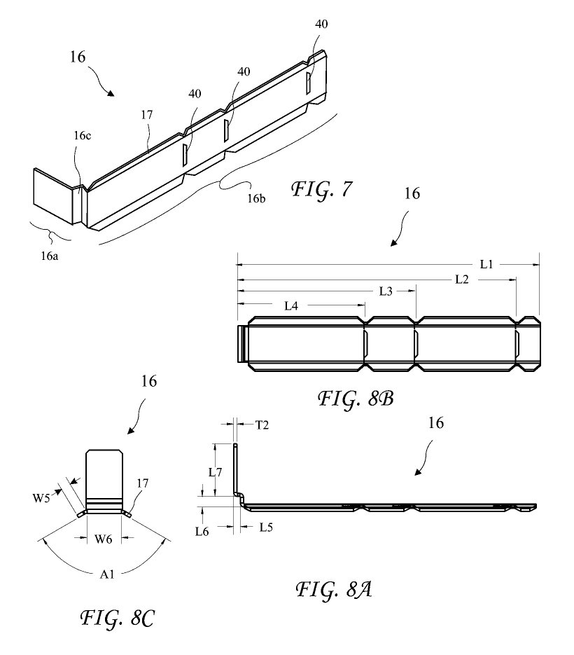

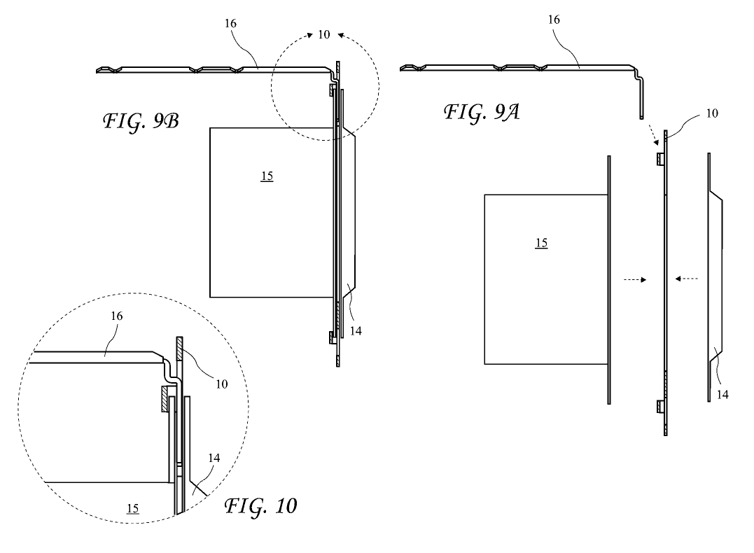

A brace mouth 22, twist-out portion 24, and a recessed portion 23 forming a bridge between the brace mouth 22 and twist-out portion 24, are provided above and below the mouth 20. The twist-out portions 24 may be broken away from the mounting bracket 10 by simple twisting, and an insertion portion 16a (see FIGS. 7, 9B, and 10) of the brace 16 may be inserted through the brace mouth 22 and into the space previously occupied by the twist-out portion 24. When the plaster ring 14 and junction box 15 are attached to the mounting bracket, the insertion portion 16a is sandwiched between the plaster ring 14 and junction box 15, thereby holding the brace 16 in place (see FIGS. 9B and 10).

The alignment features 30 reside near the top and bottom of the mounting bracket 10 on the ganging section 10d and cooperate with cooperating features 34 on the extending portion 10a. The alignment features 30 are spaced far enough away from the mounted junction box 15 to allow overlapping the extending section 10a with the ganging section 10d without interfering with mounting the junction box 15 to the mounting bracket 10. The alignment features 30 are preferably forward extending cylindrical rings which engage the cooperating features 34 which are round passages to align the ganged mounting brackets. The receptacles 28 are preferably formed by drawing steel during a stamping process in order to obtain a longer thread engagement than only plate thickness would provide. The receptacles 28 are preferably initially un-threaded to accommodate self-tapping screws, and the alignment features 30 help maintain the alignment of ganged mounting brackets 10 while the self-tapping screws engage the receptacles 28. Alternatively, the receptacles 28 may be pre-threaded with 8-32 threads. In either instance, the receptacles 28 receive screws passing through the holes 32 in the extending portion 10a to connect the ganged mounting brackets.

The combined extending section 10a and stud attachment section 1b have a width W2 of preferably approximately 2.17 inches and the combined box mounting section 10c and ganging section 10d have a combined width of preferably approximately 5.83 inches. The recessed portion 23 has a width W3 of preferably approximately 0.73 inches and is precessed a depth D1 of preferably approximately 0.086 inches. The receptacles 28 and alignment features 30 are spaced a width W4 of preferably approximately 0.25 inches from an adjacent edge of the bracket 10. The mounting bracket 10 has a height H1 of preferably approximately 6.5 inches. The extending section 10a and the stud attachment section 10b are preferably forward offset from the box mounting section 10c and the ganging section 10d by a depth D2 of preferably approximately the thickness of the sheet metal the bracket is formed from, and more preferably by approximately 0.06 inches.

A perspective view of the brace 16 according to the present invention, and used with the mounting bracket 10, is shown in FIG. 7, a side view of the brace 16 is shown in FIG. 8A, a top view of the brace 16 is shown in FIG. 8B, and an end view of the brace 16 is shown in FIG. 8C. The brace 16 includes the insertion portion 16a which is inserted through the brace mouth 22 and into the cavity created by breaking away the twist-out portion 24 of the mounting bracket 10. Once in place, the insertion portion 16a is held in place by sandwiching the insertion portion 16a between the plaster ring 14 and the junction box 15. The brace 16 includes three cut-outs 40 spaced apart along a reaching portion 16b of the brace 16. The brace 16 may be shortened by snapping off an unused portion of the brace 16. The brace 16 is thus adapted for wall thickness and provides support against the junction box 15 being pushed backwards into the wall, where such support is needed. For example, where the mounting brackets are ganged as in FIG. 2. The brace 16 has a square shoulder 16c at the intersection of the insertion portion 16a and the reaching portion 16b for cooperation with the brace mouth 22 and recessed portion 23 to position the brace 16 on the bracket 10. The square shoulder 16c has sides with a length L5 of preferably approximately 0.13 inches.

The reaching portion 16b has an overall length L1 of preferably approximately six inches. The cut-outs 40 are spaced at lengths L2, L3, and L4 from the insertion portion 16a, the lengths L2, L3, and L4 being preferably approximately 5.5 inches, 3.5 inches, and 2.5 inches to accommodate different wall thicknesses. The brace 15 has a width W6 of preferably approximately 0.68 inches and wings 17 having width W5 of preferably approximately 0.17 inches and separated by an angle A1 of preferably approximately 120 degrees. The insertion portion 16a alone has a length L7 of preferably approximately 1.04 inches. The shoulder 16c has a first length L5 in the direction of the reaching portion 16b of preferably approximately 0.13 inches and a second length L6 in the direction of the insertion portion 16a of preferably approximately 0.21 inches. The brace 16 has a thickness T2 of preferably approximately 0.06 inches.

A side view of the bracket 10, brace 16, junction box 15, and plaster ring 14 before assembling is shown in FIG. 9A and a side view of the bracket 10, brace 16, junction box 15, and plaster ring 14 after assembling according to the present invention is shown in FIG. 9B. A side view of detail 10 of FIG. 9B is shown in FIG. 10. The bracket 10 is seen to be sandwiched between the box 15 and plaster ring 14.

While the invention herein disclosed has been described by means of specific embodiments and applications thereof, numerous modifications and variations could be made thereto by those skilled in the art without departing from the scope of the invention set forth in the claims.

I claim:

1. A mounting bracket for junction boxes, the mounting bracket comprising:
a box mounting section for sandwiching between a plaster ring and the junction box;
a junction box mouth in the box mounting section for accessing wiring in the junction box;
a stud attachment section on one side of the box mounting section for attaching to a vertical stud;
an extending section reaching past the stud attachment section, the extending section for providing bracing against an inside surface of drywall on a side of the vertical stud opposite the box mounting section, to resist pushing of the box mounting section into the wall.

2. The mounting bracket of claim 1, wherein;
the stud connecting section is approximately the width of a stud; and
the extending section reaches approximately 0.4 inches past the stud connecting section to resist pushing of the box mounting section into the wall.

3. The mounting bracket of claim 1, wherein;
the mounting bracket includes a ganging section reaching past the box mounting section opposite the stud connecting section; and
the extending section includes features for attaching to the ganging section of an adjacent mounting bracket to gang the mounting brackets.

4. The mounting bracket of claim 3, wherein the stud connecting section and the extending section are aligned and are forward offset by approximately the thickness of sheet metal the mounting bracket is formed from, thereby aligning the box mounting sections of the ganged mounting brackets.

5. The mounting bracket of claim 3, wherein the extending section and the ganging section include cooperating alignment features to aligning the extending section and the ganging section before attaching the extending section to the ganging section.

6. The mounting bracket of claim 3, wherein the box mounting section includes a brace attaching feature for attaching a brace reaching behind the ganged mounting brackets to provide rearward support.

7. The mounting bracket of claim 6, wherein the brace attaching feature comprises two brace attaching features, one above the junction box mouth and one below the junction box mouth of the box mounting section.

8. The mounting bracket of claim 7, wherein the brace attaching features comprise a brace mouth and a bridge and an open space between the brace mouth and the junction box mouth brace and opening into the junction box mouth.

9. The mounting bracket of claim 1, wherein the bridge is recessed a depth D1 of about thickness of sheet metal the mounting bracket is formed from and the brace includes a reaching portion reaching behind the mounting bracket top contact a wall surface to brace the mounting bracket and an insertion portion perpendicular to the reaching portion, the insertion portion inserted through the brace mouth and residing in the open space for sandwiching between a junction box and a plaster ring.

10. The mounting bracket of claim 9, wherein the brace includes a shoulder between the reaching portion and the insertion portion and the shoulder cooperates with the bridge to limit the insertion of the insertion portion into the open space.

11. A set of grouped junction box mounting brackets for junction boxes comprising:
a first mounting bracket and a second mounting bracket, each mounting brackets comprising:
a box mounting section for sandwiching between a plaster ring and the junction box, the box mounting section including:
a junction box mouth of accessing the interior of the junction box; and
a brace mouth;
a bridge; and
an open space, the bridge and the open space between the brace mouth and the junction box mouth;
a stud attachment section on one side of the box mounting section attachable to a vertical stud and forward offset from the box mounting section by a depth D2 of about the thickness of sheet metal the mounting bracket is formed from;
an extending section aligned with the stud attachment section and reaching past the stud attachment section opposite to the box mounting section;
a junction box mouth in the box mounting section for accessing wiring in the junction box; and
a ganging section reaching past the box mounting section opposite the stud connecting section;
the stud attachment section of the first mounting bracket attached to a vertical stud and the ganging section of the first mounting bracket attached to the extending section of the second mounting bracket; and
a brace having a reaching portion and an insertable portion perpendicular to the reaching portion, the insertable portion inserted though the brace mouth of the second mounting bracket and sandwiched between the junction box and the plaster ring.

12. A set of grouped junction box mounting brackets for junction boxes comprising:
a first mounting bracket and a second mounting bracket, each mounting brackets comprising:
a box mounting section for sandwiching between a plaster ring and the junction box, the box mounting section including:
a junction box mouth of accessing the interior of the junction box; and
a brace mouth;
a bridge; and
an open space, the bridge and the open space between the brace mouth and the junction box mouth;
a stud attachment section having about the same width as a vertical stud and forward offset from the box mounting section by a depth D2 of about the thickness of sheet metal the mounting bracket is formed from, the stud attachment section on one side of the box mounting section and attachable to a vertical stud;
an extending section aligned with the stud attachment section and reaching past the stud attachment section opposite to the box mounting section; and
a ganging section reaching past the box mounting section opposite the stud connecting section;
the stud attachment section of the first mounting bracket attached to a vertical stud; and
the ganging section of the second mounting bracket overlappingly attached to the extending section of the first mounting bracket, the mounting brackets ganged across the vertical stud, the overlap of the ganging section and the extending section laterally offset from the vertical stud.
